(19) United States
(12) Patent Application Publication
(10) Pub. No.: US 2019/0191317 A1
(43) Pub. Date: Jun. 20, 2019

(54) Coordinated Interference Mitigation in Communication Systems

(71) Applicant: Skyriver Communications, Inc., San Diego, CA (US)

(72) Inventors: Saeid Safavi, San Diego, CA (US); Saeed Sarikhani Khorami, Carlsbad, CA (US)

(21) Appl. No.: 15/842,416

(22) Filed: Dec. 14, 2017

(51) Int. Cl. H04W 24/02; H04L 5/00; H04W 16/14

(52) U.S. Cl. CPC H04W 24/02; H04W 16/14; H04L 5/0035

(57) ABSTRACT

Embodiments are directed to a Coordination and Control Center (CaCC) in communication with a plurality of base stations including a first base station and a first subscriber unit of a communication system, the CaCC including an Interference Mitigation Circuit configured to: (a) receive information regarding a source of interference affecting radio frequency communications between a first base station and a first subscriber unit of a communication system, wherein the source is at least one of a second base station or a second subscriber unit within the communication system; and (b) provide instructions to the source from the CaCC to mitigate the interference between the affected first base station and first subscriber unit.

### BACKGROUND

### (1) Technical Field

The disclosed methods and apparatus relate to radio frequency communication and more particularly to mitigating the effects of interference in a millimeter wave communication system.

### (2) Background

As the use of wireless communications continues to increase, substantial progress is being made to formulate standards that govern protocols for how such communications occur. These standards are relevant to several types of communications systems, including cellular telephony, point to point communications, point to multipoint communications, short-range communications, and long-range communications using smaller cells (e.g., picocells and femto cells). Some of the industry standards, such as 802.11ax, contemplate using multiple input, multiple output (MIMO) technology to assist in increasing the system capacity and contemplate the possibility of providing service over longer ranges than the current 802.11 WiFi systems provide. In addition, a 5G communications standard is evolving to consider use of millimeter wavelength signals, such as signals that operate at frequencies in the range of 30-300 GHz. The use of smaller cells can increase the overall system capacity by allowing greater frequency reuse. In addition, providing base station sectors that are divided into subsectors further enhances the ability to increase capacity through even greater frequency reuse. The use of such advanced techniques and high frequencies pose significant challenges, such as in establishing an architecture that can support higher frequencies and provide efficient, cost effective practical solutions to rolling out such a system on a large scale. Meeting these challenges requires substantial planning and product development.

Already contemplated by Skyriver, a leading-edge millimeter wave (mmWave) broadband provider transforming broadband, are systems that use concepts developed for use in short range 802.11n and 802.11ac compliant systems, together with mmWave transceivers. But while the concepts used in 802.11 systems have advanced, additional advances in conforming products and systems are necessary to take full advantage of some of the new features provided in the newest forms of 802.11, such as 802.11ax. As design and implementation of next generation networks operating in mmWave frequencies is growing, specific attention should be paid to inter-cell and intra-c ell interference Therefore, there is currently a need to improve detection and mitigation of interference affecting communication at microwave frequencies between base stations and subscriber units attempting to communicate with the base stations.

### SUMMARY

The disclosed method and apparatus provides an architecture that mitigates the effects of interference in radio frequency communication systems. In general, such systems have one or more base stations. Each base station is responsible for communicating with several subscriber units.

In some embodiments, a communication system includes a Coordination and Control Center (CaCC) in communication with at least one base station site. At least one of the base station sites includes a first base station in communication with a first subscriber unit of the communication system. The CaCC includes an Interference Mitigation Circuit configured to: (a) receive information regarding a source of interference affecting radio frequency communications between a first base station and a first subscriber unit of the communication system, wherein the source is at least one of a second base station or a second subscriber unit within the communication system; and (b) provide instructions to the source from the CaCC to mitigate the interference between the affected first base station and first subscriber unit.

In an example scenario, the first base station resides at a base station site having a plurality of base stations. The base station is responsible for communicating with subscriber units that reside within a corresponding sector of the base station site. The source of interference is: (a) a second base station within the base station site; or (b) a second subscriber unit in a different sector of the base station site. In another example scenario, the communication system includes a plurality of base station sites, each base station site having a plurality of base stations. A first base station resides within a first of the plurality of base station sites. A second base station resides within a second of the plurality of base station sites. The source of interference is: (a) the second base station; or (b) a subscriber unit within a sector of the second base station site. In each scenario, the CCaC is configured to mitigate the inference by providing the source with instructions to reschedule or re-route its transmission, or to switch to another communication frequency or sub-channel in a frequency.

The details, features, objects, and advantages of one or more embodiments of the disclosed method and apparatus are set forth in (or contemplated to be apparent from) the accompanying drawings, the description and claims below.

### DESCRIPTION OF THE DRAWINGS

FIG. 1 is an illustration of a base station site and several (subscriber units within a millimeter wave (mmWave) communication system.

FIG. 2 is another illustration of the base station coverage area.

FIGS. 3A-B are illustrations of the Earth, a radius through a base station site on the surface of the earth, and an X-Y plane tangential to the surface of the earth and perpendicular to the radius.

FIG. 4 is a simplified block diagram of a set of base stations within a base station site.

FIG. 5 is an illustration showing the base stations of a base station site.

FIG. 6 shows another illustration of such a system in which several base station sites and a Coordination and Control Center (CCC) are coupled to the core network.

FIG. 7 is an illustration of an alternative embodiment in which base stations within the same base station site are part of a wired local area network and/or a wireless local area network.

FIG. 8 is a simplified block diagram of one embodiment of some portions of a base station site, including some of the details of the transmit portion of a base station sector radio.

FIG. 9 is a simplified block schematic of the components of the RF TX chain. The RF TX chain has several inputs.

FIG. 10 is a simplified block diagram of one embodiment of some portions of a base station site, illustrating some of the details of the receive portion of a base station sector radio.

FIG. 11 is a simplified schematic of the components of the RF receive chain.

FIG. 12 is a simplified schematic of a base station site illustrating some of the transmit components of the sector radio in accordance with an alternative embodiment such as the base stations shown in FIG. 7 in which a coordination control module is shared by all of the base stations.

FIG. 13 is a simplified schematic of the base station site of FIG. 12 illustrating some of the receive components of the sector radio.

FIG. 14 is an illustration of multiple base station sites configured to communicate with a Coordination and Control Center according to some embodiments of the present disclosure.

FIG. 15 is a flow diagram illustrating the operation of some embodiments of the present disclosure for mitigating the effects of interference in radio frequency communication systems.

FIGS. 16-28 illustrate various interference scenarios in which the operation disclosed in FIG. 15 may be performed.

Like reference numbers and designations in the various drawings indicate like elements.

### DETAILED DESCRIPTION OF THE INVENTION

Embodiments are described herein in the context of an architecture that mitigates the effects of interference in radio frequency communication systems, such as millimeter wave (mmWave), communication systems. Embodiments provided in the following description are illustrative only and not intended to limit the scope of the present disclosure.

In the interest of clarity, not all of the routine features of the embodiments described herein are shown and described. It will be appreciated that in any such actual implementation, numerous implementation-specific details that are not expressly disclosed may nevertheless exist in order to achieve goals such as compliance with application- and business-related constraints. In addition, the specific goals can vary from embodiment to another.

The disclosure is not restricted to the particular embodiments or implementations described as such. For example, references that are made to a particular means for implementing a feature, structure, operation, or other characteristic in one particular embodiment should be taken as providing support for such implementation in other disclosed embodiments. Accordingly, any particular feature, structure, operation, or other characteristic described in this specification in relation to one embodiment may be combined with other features, structures, operations, or other characteristics described in respect of any other embodiment. The appearance of the phrases “some embodiments” or variations of this phrase in various places in the specification does not necessarily refer to the same embodiment or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

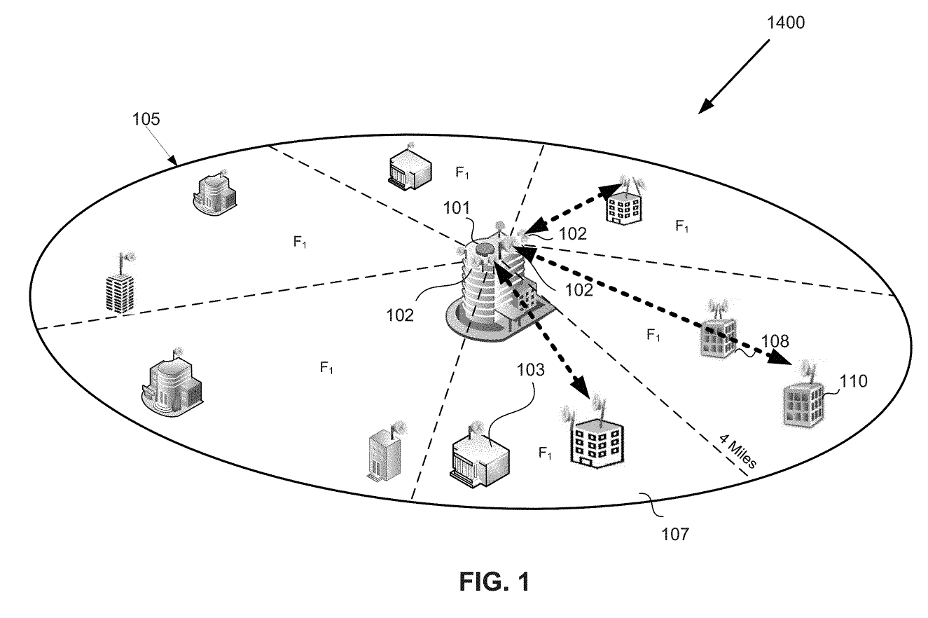

FIG. 1 is an illustration of a base station site 101 and several subscriber units 103 within a millimeter wave (mmWave) communication system 100. In some embodiments, several base stations 102 are located at each base station site 101. The base station site 101 serves as a hub for communications to the subscriber units 103. The system provides point-to-multipoint communications from the base station site 101 to each subscriber unit 103 over a “downlink”. In addition, the base station site 101 provides multipoint-to-point communications from each subscriber unit 103 to a base station 102 at the base station site 101 over an “uplink”. Subscriber units 103 may be located within various types of facilities, such as residential buildings, office buildings, towers of base stations within one or more mobile communications networks. A base station site coverage area 105 (i.e., the geographic area serviced by the base stations 102 within a base station site 101, hereafter referred to as the “site coverage area” for the sake of brevity) is divided into several base station sector coverage areas 107 (hereafter referred to as “sector coverage areas” for the sake of brevity). In some embodiments, each base station 102 within the base station site 101 services one sector of the site coverage area 105. Accordingly, each base station 102 is associated with a corresponding sector coverage area 107. Each base station 102 is responsible for communicating with all of the subscriber units 103 within the corresponding sector coverage area 107. In the embodiment shown in FIG. 1, the site coverage area 105 is divided into six such sectors coverage area 107. For the sake of simplicity, the site coverage area 105 is shown in FIG. 1 as a generally circular area with a radius of approximately 4 miles. Each sector coverage area 107 is shown as an essentially pie shaped region. It should be understood however that the actual site coverage area 105 may not have a uniform shape, but rather a shape that is dependent upon obstructions, terrain and other transmission channel factors. Furthermore, each sector coverage area 107 may intersect with one or more adjacent sector coverage area 107 to a greater or lesser degree than is shown in the embodiment of FIG. 1. Furthermore, in some embodiments, each sector coverage area 107 may be substantially different in size and shape from one or more of the other sector coverage areas 107.

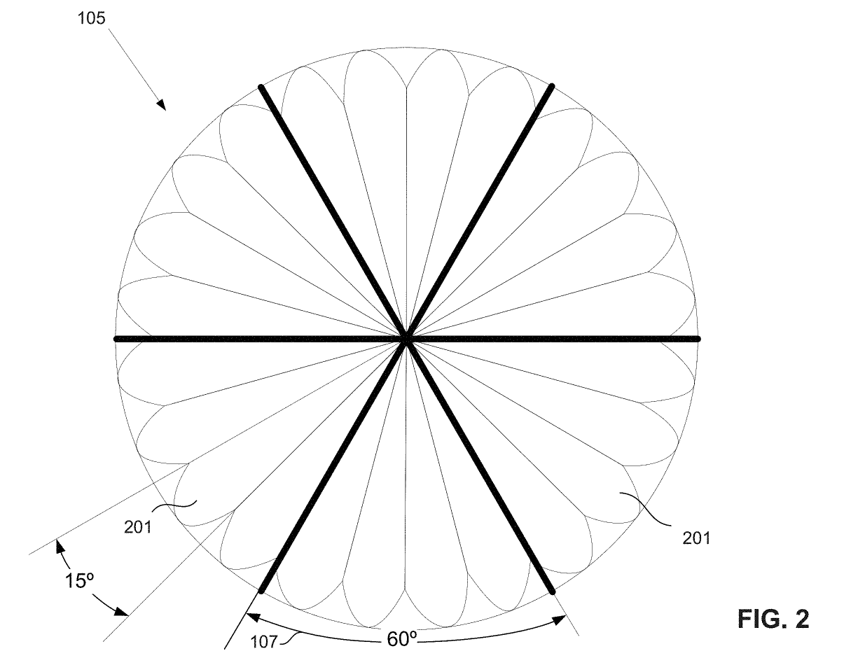

FIG. 2 is another illustration of the site coverage area 105. In various embodiments of the disclosed method and apparatus, the particular number of sector coverage areas 107 may vary from that illustrated in FIG. 1 and FIG. 2. In the embodiment shown in FIG. 2, each sector coverage area 107 is divided into four subsectors 201. Each subsector 201 extends out from the base station 102 with an azimuth angle of approximately 15 degrees, wherein the azimuth angle is an angle on an X-Y plane approximately perpendicular to the Earth's radius through the site of the base station 102.

The particular number and shape of the subsectors 201 may vary from the number shown in the embodiment illustrated in FIG. 2. However, having four subsectors is compatible with a system in which an 802.11 compliant MAC provides 8 spatial streams, two of which can transmitted into each subsector with each of the two being transmitted on a different polarization. In some embodiments, each of the two polarizations associated with one subsector are orthogonal. A sub-sector antenna (not shown in FIG. 1 or 2) is associated with each corresponding polarization of each subsector and defines the shape and size of the subsectors 201 within the sector coverage area 107, as will be discussed in greater detail below. Accordingly, in such embodiments, there are 8 such subsector antennas within each sector.

As is the case with the sector coverage areas 107, each subsector 201 can have a substantially different size and shape from that of the other subsectors 201 within the same sector coverage area 107 or from the other subsectors 201 in each other sector coverage areas 107. Furthermore, in some embodiments, there may be more or less than 6 sectors, each with more or less than 4 subsectors. In some embodiments, the sum of all of the azimuth angles for each sector may not be equal to 360 degrees. Accordingly, there may be some holes in the coverage where no subscriber units 103 are expected to be present, or in other embodiments, there may be an overlap in the coverage of two or more adjacent sectors. In addition, in some embodiments, the number of subsectors may vary from one sector to another and one or more subsectors may have different azimuth angles than one or more of the subsectors within the same sector or within other subsectors.

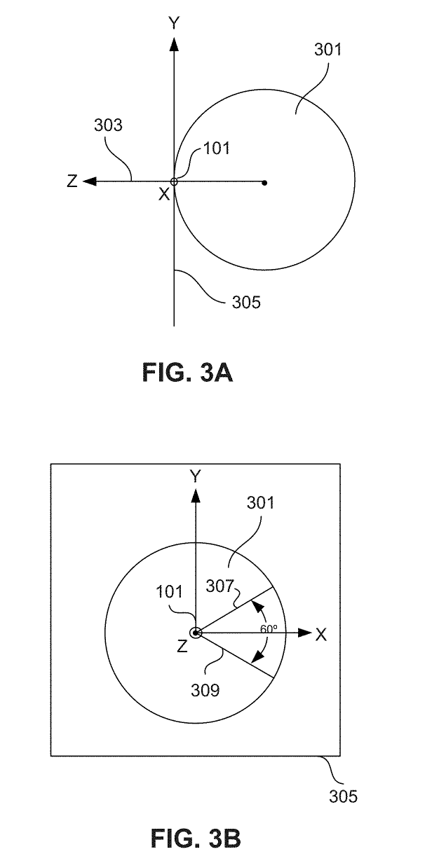

FIG. 3A is an illustration of the Earth 301, a radius 303 through a base station site 101 on the surface of the earth 301, and an X-Y plane 305 tangential to the surface of the earth 301 and perpendicular to the radius 303. FIG. 3A is oriented such that the X-axis extends outward, the Y-axis extends upward and the Z-axis extends to the left.

FIG. 3B is an illustration of the Earth 301, the X-Y plane 305 and a pair of rays 307, 309 emanating from the base station site 101 that define an azimuth angle of 60 degrees. The orientation of the illustration in FIG. 3B is rotated 90 degrees about the Y-axis with respect to the illustration of FIG. 3A. Accordingly, in FIG. 3B, the Y-axis extends upward, the X-axis extends to the right and the Z-axis extends outward (making the radius 303 extend outward and thus not visible in FIG. 3B). As can be seen in FIG. 3B, azimuth angle lies on the X-Y plane. It should be clear that the radius of the Earth is significantly greater than the dimensions of the site coverage area 105. Therefore, that portion of the X-Y plane 305 that is coincident with the site coverage area 105 is generally also coincident with the surface of the Earth. Furthermore, rays emanating from the base station site 101 that lie on the plane 305 are projected from the base station site 101 at an elevation angle of zero degrees. Contours of the Earth's surface, however can be taken into account when aiming the antennas. Therefore, the center of any beam transmitted from a base station 102 within the base station site 101 may be at an elevation angle other than zero degrees.

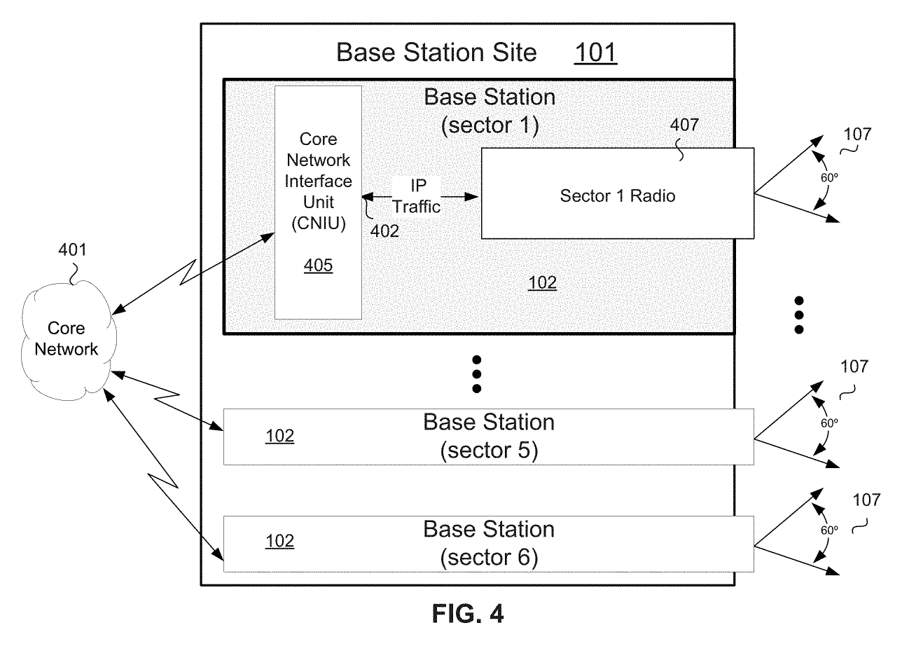

FIG. 4 is a simplified block diagram of a plurality of base stations 102 within a base station site 101. In the embodiment shown in FIG. 4, the base station site 101 has 6 base stations 102. Accordingly, there are 6 sector coverage areas 107 in the site coverage area 105. Each sector coverage area 107 is serviced by a base station 102 having a coverage area with an azimuth angle of approximately 60 degrees. In some embodiments, each base station 102 has a core network interface unit (CNIU) 405. The CNIU 405 provides a means by which the base station 102 can communicate, such as via IP Traffic 402, with other nodes on a core network 401. Accordingly, in some embodiments, the CNIU 405 provides access to other base stations at other base station sites or other base stations located at the same base station site 101.

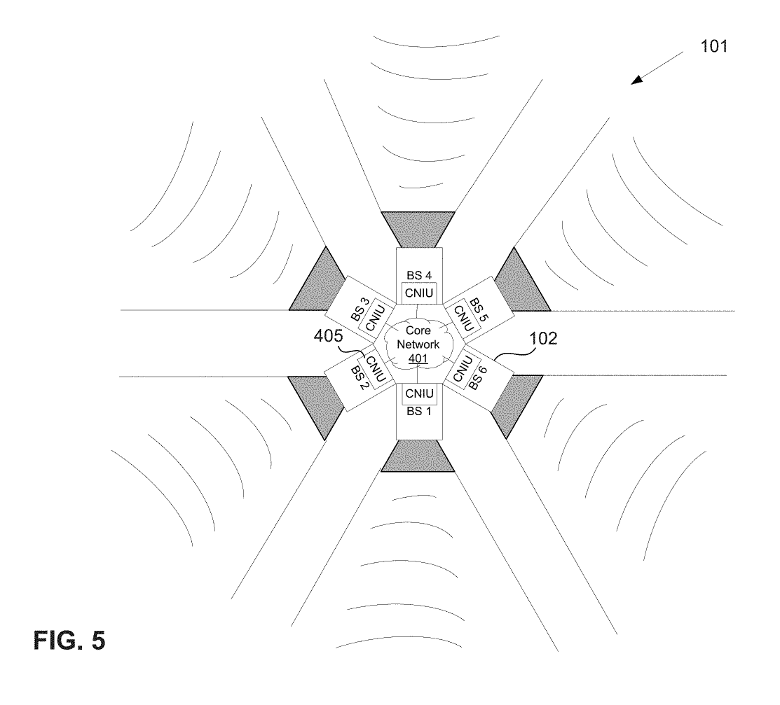

FIG. 5 is an illustration showing the base stations 102 of a base station site 101. Each of the six base stations 102 are coupled to a core network 401 in accordance with some embodiments of a communication system. Only one base station site 101 is shown in FIG. 5 for the sake of simplicity.

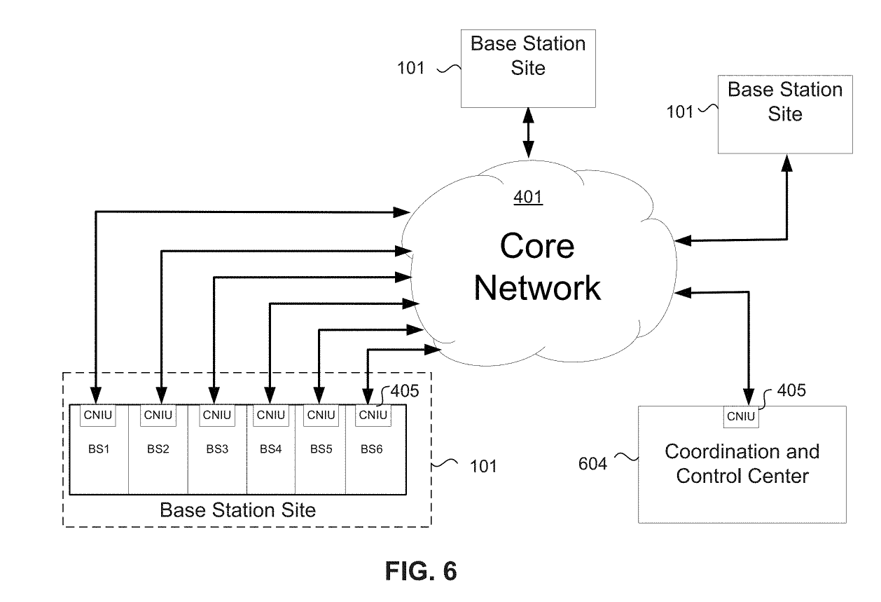

FIG. 6 shows another illustration of such a system in which several base station sites 101 and a Coordination and Control Center (CCC) 604 are coupled to the core network 401. The CCC 604 has a CNIU 405. The CNIU 405 allows the CCC 604 to be a node on the Core Network 401. In FIG. 6, the base stations 102 and core network interface unit of only one base station site 101 are shown. The other two base station sites 101 are shown as blocks for the sake of simplicity. In some such embodiments, the CCCs 604 coordinate operations between base stations 102 within each base station site 101.

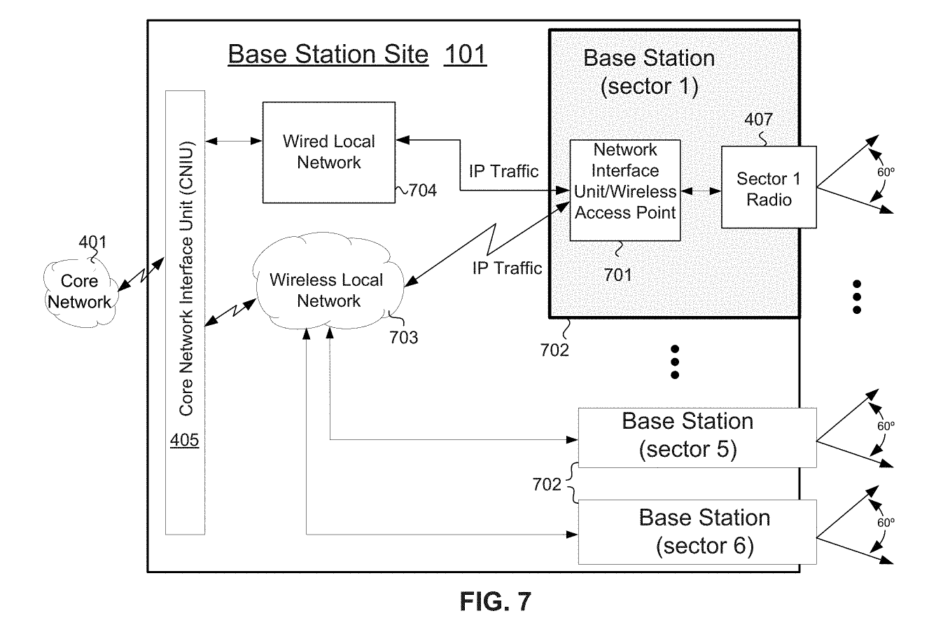

FIG. 7 is an illustration of an alternative embodiment in which base stations 702 within the same base station site 101 are part of a wired local area network 704 and/or a wireless local area network 703. Therefore, each base station 702 has a network interface unit (NIU) 701 that provides access to the local area network 704, 703. A CNIU 405 is also a node on the local area network 704, 703. Accordingly, each base station 702 can access the core network 401 through the local area network 704, 703 through one CNIU 405 that is present in the base station site 101.

In either the case of the base station 102 or the base station 702, the base station site 101 provides a means by which subscriber units 103 can be connected to devices that are part of a private network, public network or the Internet through devices (such as Internet gateways) connected to the core network. In addition, in some embodiments, the base station 102, 702 can provide communication links through sector radios 407 of the base station 102, 702 to allow two or more of the subscriber units 103 to communicate with each other through the base station 102, 702.

It should be noted that throughout the remainder of this document, references to the base station 102 apply equally to the base station 702.

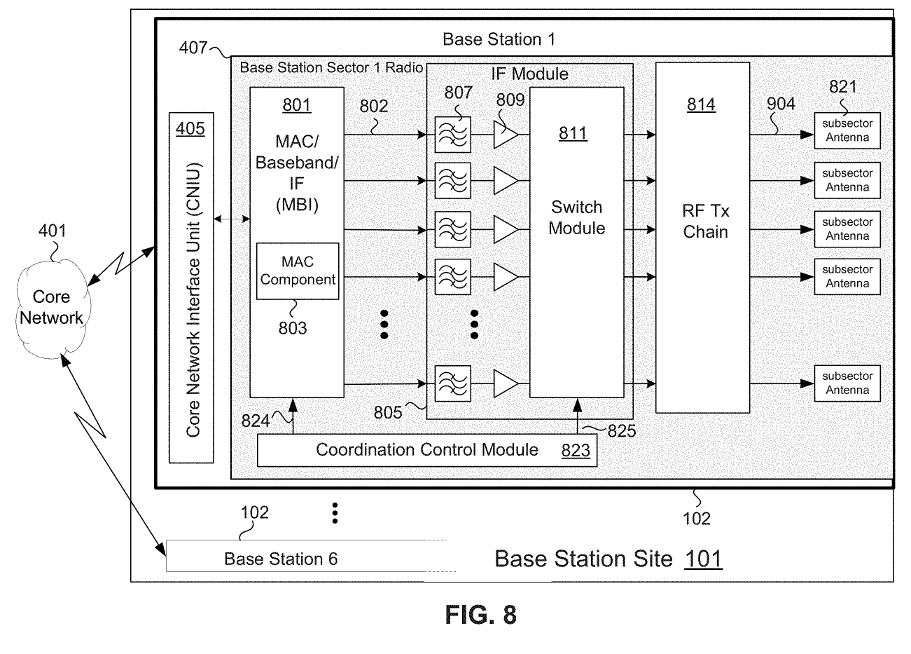

FIG. 8 is a simplified block diagram of one embodiment of portions of a base station site 101, including some of the details of the transmit portion of a base station sector radio 407. For the sake of simplicity, only one base station sector radio 407 is shown in detail. In addition, only the transmit related components are shown in FIG. 8.

In the embodiment shown in FIG. 8, each base station 102 transmits mmWave signals into the sector coverage area 107 corresponding to that base station 102. Each of the six base stations 102 has a corresponding base station sector radio 407. In some embodiments, each such base station sector radio 407 has essentially the same architecture. However, in other embodiments, the architecture of one or more of the base station sector radios 407 may differ from the rest. In some such embodiments, each of the base station sector radios 407 has an architecture that is uniquely configured for the needs of the particular sector coverage area 107 that the radio 407 services.

In some embodiments of a base station 102 shown in FIG. 8, signals containing content to be transmitted by the radio 407 are coupled from the CNIU 405 to a MAC/Baseband/Intermediate Frequency (MBI) module 801. In some embodiments of the disclosed method and apparatus, the MBI module 801 is capable of providing spatial division, time division and frequency division outputs 802 at an intermediate frequency (IF). That is, the MBI module 801 is capable of outputting signals 802 that carry unique information through different outputs that are coupled to spatially diverse antennas, and thus provide spatial division.

In addition, the MBI module 801 is capable of outputting signals 802 to each output, wherein each such signal has unique content at different times. Thus, the outputs provide time division multiplexed signals. Still further, the MBI module 801 is capable of providing unique content concurrently through each output at different frequencies, thus provide frequency division multiplexed signals. In some such embodiments, the MBI module 801 includes at least an 802.11 module, such as module capable of operating in conformance with one of the following: industry standard 802.11(n), 802.11(ac), 802.11(ax), etc. In some embodiments, the MBI module 801 implements a technique commonly referred to as multiple-input multiple-output (MIMO) to generate spatial division outputs. Each spatial division output is commonly referred to as a “spatial stream” (SS). In some embodiments, such as those that have a MBI module 801 that operates in conformance with 802.11(ac) or 802.11(ax), the MBI module 801 may have eight output ports that each output one SS 802. A media Access Control (MAC) component of the MBI module 801 (which in some embodiments is within the 802.11 module of the MBI module 801) determines how the content that is coupled to the MBI module 801 is to be assigned to each SS 802. In addition to determining which SS 802 the content is to be assigned, the MAC component 803 also determines time and frequency division allocations. That is, the MAC component 803 determines in what time slot and to which frequency the content is to be applied in each particular SS 802.

In some embodiments, each SS 802 is associated with a corresponding TX input to an IF module 805. In some such embodiments, the IF module 805 comprises a switch module 811 and several filters 807, each filter 807 associated with a corresponding amplifier 809. Since FIG. 8 shows only components that are associated with the transmit function, only those TX amplifiers 809 and TX filters 807 that are in the transmit signal path are shown in FIG. 8.

Each TX output from the MBI module 801 is associated with a corresponding one of the IF module TX inputs and the corresponding TX filter 807. The output of each TX filter 807 is coupled to the input of the corresponding TX amplifier 809. It will be understood by those skilled in the art that the use of particular amplifiers and filters will depend upon the requirements of each particular system. Therefore, it should be understood that the configurations disclosed herein are merely provided as examples of systems. Therefore, significant variations in the amount of filtration and amplification are within the scope of the disclosed method and apparatus.

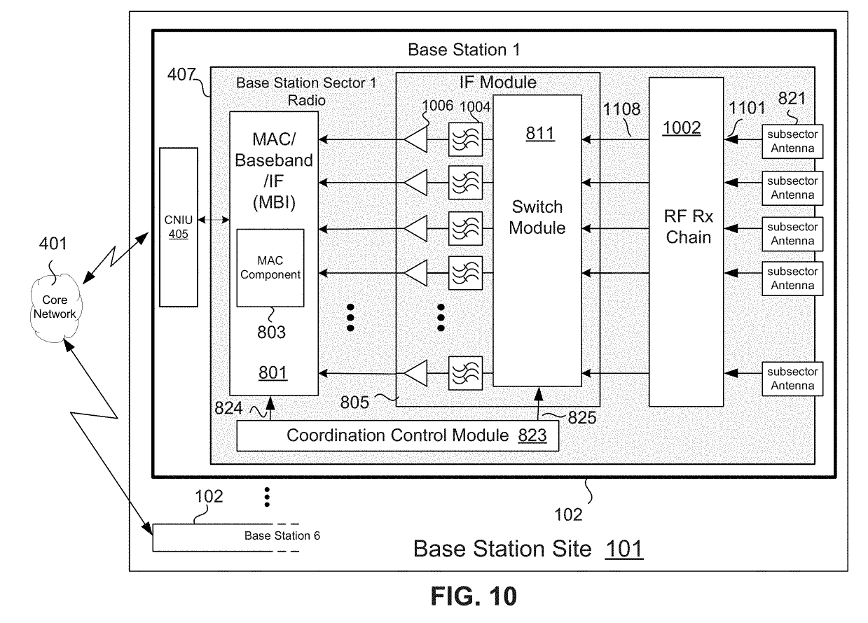

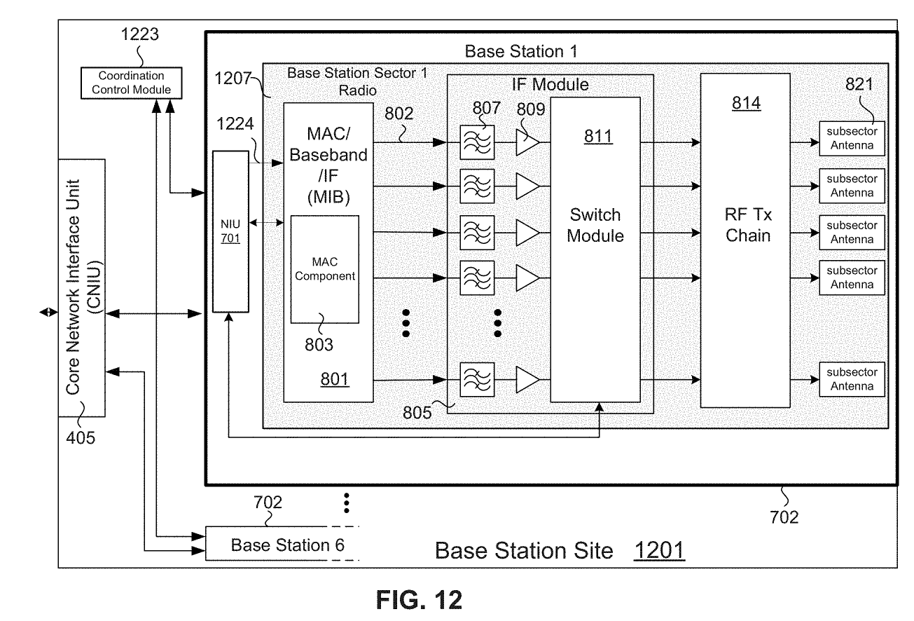

The output of each TX amplifier 809 is associated with, and coupled to, a corresponding TX input to a switch module 811 within the IF module 805. The switch module 811 comprises a switch network that makes it possible to selectively connect any one input to any one output. Likewise, each output can be connected to any one input. Therefore, there is a selectable one-to-one correspondence between TX inputs and TX outputs of the switch module 811. Other embodiments may provide a switch module that is capable of selectively connecting one or more inputs to one or more outputs. Each TX output from the switch module 811 is associated with a corresponding input to an RF transmit (TX) chain 814. It should be noted that the switch module 811 also comprises RX inputs and RX outputs that will be discussed further below with respect to FIG. 10 and FIG. 11.

While the MBI 801 shown in FIG. 8 has several TX outputs, in some embodiments, the MBI 801 may have as few as two TX outputs, each associated with a corresponding one of two subsector antennas 821. In some such embodiments, the two subsector antennas 821 are focused into the same subsector and transmit signals with different polarizations (e.g., horizontal polarization and vertical polarization).

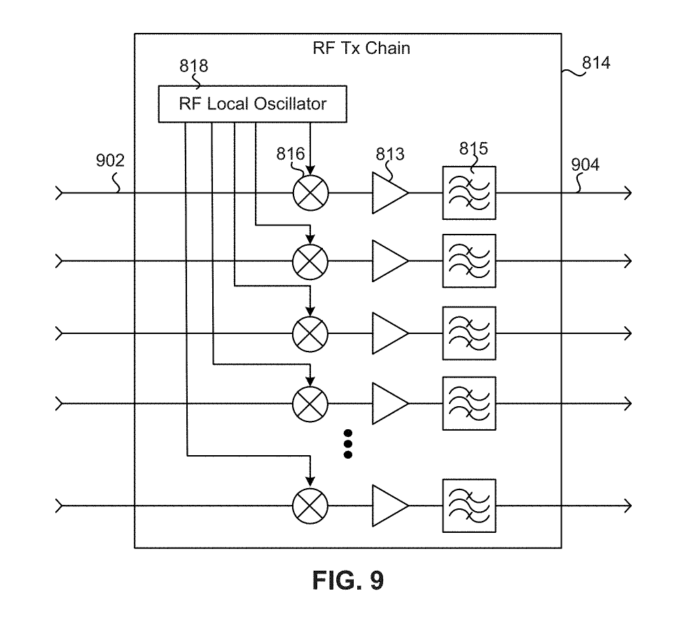

FIG. 9 is a simplified block schematic of the components of the RF TX chain 814. The RF TX chain 814 has several inputs 902. Each input 902 is associated with a corresponding frequency converter 816, amplifier 813, filter 815 and output 904. Each RF TX chain input is coupled to a corresponding IF input of the corresponding frequency converter 816. A local oscillator 818 provides a local oscillator signal to each frequency converter 816. Each frequency converter 816 mixes the input signal with the local oscillator signal to upconvert the IF signal to a millimeter wave frequency that is output from the frequency converter 816. The upconverted signal output from each frequency converter is coupled to the corresponding amplifier 813. The output of each amplifier 813 is coupled to the input of the corresponding filter 815.

Referring back to FIG. 8, each output 904 from the RF TX chain 814 is associated with, and coupled to, a corresponding input to a subsector antenna 821. Each input to the subsector antenna 821 is configured to form a beam directed to a corresponding subsector 201 of the sector coverage area 107 serviced by the base station sector radio 407. In some embodiments, there are two inputs focused into the same subsector 201. The first is applied to elements of the antenna that polarize the signal in a first polarization. The second is applied to elements of the antenna that polarize the signal in a second polarization orthogonal to the first polarization. For example, in some embodiments, a first input to the sector antenna 821 is coupled to elements that transmit signals in a beam focused upon a first subsector 201 and having a horizontal polarization. A second input to the sector antenna is coupled to elements that transmit signals in a beam focused upon a second subsector 201 and having a vertical polarization. Therefore, by selecting a particular output of the switch module 811 to which a particular input of the switch module 811 is to be coupled, the signal output from the amplifier 809 is selected for transmission on a transmission beam that is focused into the subsector 201 associated with the selected switch module output. In some embodiments, selecting a particular output further determines the polarization on which the signal will be transmitted. In the embodiment in which there are four subsectors 201, there eight subsector antennas 821. The subsector antennas 821 are paired such that each pair of subsector antennas 821 is focused to transmit beams into one of the four subsectors. A first subsector antenna 821 of each pair transmits signals having a first of two orthogonal polarizations (e.g., vertical or horizontal). The second subsector antenna 821 of the pair transmits signals on the second of the two orthogonal polarizations. Accordingly, each output of the switch module 811 is associated with a corresponding subsector antenna 821 focused to transmit a signal into a unique one of the four subsectors 201. Furthermore, the combination of polarization and subsector 201 is unique for each output of the switch module 811.

Ideally, in a typical 802.11 configuration, such as an 802.11(ax) configuration, each SS 802 is coupled to a different antenna to provide the spatial diversity desired to implement a MIMO transmission. In the embodiment of FIG. 8, a multi-user MIMO system is used in which each pair of SSs carries different content to subscriber units 103 in a different subsector 201. At least two antennas within the receiver of each subscriber unit 103 can receive signals from the subsector antennas 821 of the transmitter that transmit beams into the subsector 201 in which the subscriber unit 103 resides. Some typical 802.11systems take advantage of MIMO techniques to increase the system throughput. Multipath channels are created by the creation of different signal paths that form as a consequence of the signals reflecting off various objects along the path between the transmitter and the receiver, creating associated different delays for each signal path. However, in accordance with some embodiments of the disclosed method and apparatus, rather than relying upon signals encountering multipath channels between the transmit antennas and the receive antennas, each SS is transmitted on a transmission beam that is focused into a unique subsector 201 of the sector coverage area 107 on a unique polarization. In some embodiments, two SSs are transmitted into the same subsector 201. However, the two signals are transmitted on beams that have orthogonal polarizations. By virtue of the signals being transmitted through elements of the transmit antenna that are either on different polarizations or directed at different subsectors 201, the signals will be in different channels for the purpose of the MIMO system, similar to the different spatial channels in a typical 802.11 MIMO configuration. A coordination control module 823 coordinates the assignment of SSs output from the MBI module 801 with the switch module 811 (i.e., the selection of the output to which each particular SS is coupled by the switch module 811).

In other embodiments, signals that are not completely orthogonal may be transmitted into the same subsector 201. In such embodiments, a technique commonly known as non-orthogonal multiple access (NOMA) is used in which such signals that are not completely orthogonal are transmitted on the same frequency and at the same time into the same space, relying upon a difference in polarization (or other factor that can be used to distinguish signals), but wherein the signals are not completely orthogonal. For example, a first signal may have polarization that is between horizontal and vertical (e.g., at 45 degrees from horizontal), while other signals are either strictly horizontal, strictly vertical, or 90 degrees from the first signal. While some such signals are not orthogonal, the difference in polarization is sufficient to provide some measure of separation that provides the receiver with a limited capability to distinguish the signals from one another. Therefore, while the separation of the signals is not nearly as great as for orthogonal polarizations, there is sufficient separation to provide some advantages that, when taken together with the increase in throughput, offset the negative impact of distortion created by the cross contamination of the signals.

In some embodiments of the disclosed method and apparatus, the MAC component 803 is responsible for allocating resources to each subscriber unit 103. That is, the MAC component 803 determines which SS 802 at which frequencies and at which time is to be used to transmit content to each particular subscriber unit 103. It should be noted that in addition to providing signals with time division, frequency division and spatial division, the signals provided by the MBI module 801 may be modulated using orthogonal frequency division multiplexing (OFDM). In some cases, the content modulated on various OFDM subcarriers may be intended for reception by different subscriber units 103 (i.e., orthogonal frequency division multiple access (OFDMA)). Alternatively, different OFDM subcarriers may carry different data streams intended for the same subscriber unit 103. In some embodiments, the MBI module 801 receives instructions from the coordination control module 823 that assist the MBI module 801 and the MAC component within the MBI module 801 to determine the manner in which the resources are to be allocated.

In many ways, the operation of the MAC component 803 of the disclosed method and apparatus is similar to the operation of a MAC within a conventional 802.11(n), 802.11(ac) or 802.11(ax) system. That is, the MAC component 803 need not treat the SSs 802 that are output any different from those SSs that are output from a MAC of a conventional 802.11 system. However, because SSs 802 are transmitted to the subscriber units 103 residing in different subsectors using different subsector antennas 821, determinations of Channel State Information (SCI) by the MAC component 803 needs to be coordinated with the switch module 811 within the IF module 805. For example, the channel from the base station 102 to a particular subscriber unit 103 depends upon the subsector 201 in which the subscriber unit 103 is located. The coordination control module 823 performs the function of controlling the switch module 811 in coordination with the MAC component 803 of the MBI module 801. For example, in some embodiments, when the SCI is being measured for the channel from a first output of the MBI module 801 during transmission from a first subsector antenna 821, the switch module 811 is controlled to ensure that the first output from the MBI module 801 is coupled to the first subsector antenna 821. In some embodiments, a control signal is coupled on a line 824 from the coordination control module 823 to the MBI module 801 to allow the MBI module 801 to be coordinated with the switch module 811 during a SCI procedure. In some embodiments, the switch module 811 is controlled by a signal output on a signal line 825 from the coordination control module 823. Similarly, each other output from the MBI module 801 is coupled to the appropriate subsector antenna 821 during measurements of the channel between the base station 102 and the subscriber unit 103 at issue. A further discussion regarding the determination of SCI for each channel is provided below. Once the SCI procedure is complete, the coordination control module 823 ensures that the signals that are output from the MBI module 801 are coupled to the appropriate subsector antenna 821 for transmission of MIMO signals from the base station 102 to each subscriber unit 103 to which the base station 102 is communicating. In some embodiments, such as the embodiment shown in FIG. 6, the coordination control module 823 is coupled to the MBI module 801 and also to the IF module 805. In particular, in some embodiments, the coordination control module 823 is coupled to the switch module 811 in the IF module 805.

For MIMO operations, SCI regarding the channels between the various antennas at the base station 102 and the antennas of each subscriber unit 103 must be determined. The SCI information is used by the base station to pre-code transmissions to subscriber units taking into account distortions that occur due to the nature of the transmission channel between the transmitter and the receiver. Conventions and protocols for attaining SCI are provided in the 802.11 standard. In particular, there are two protocols that are provided in 802.11 for attaining SCI. The first is referred to as “Implicit” and the second is referred to as “Explicit”.

In accordance with the Explicit technique for determining SCI, the base station 102 sends a “null data packet announcement” (NDPA) frame to the subscriber units. Usually, the NDPA frame contains the address of the intended subscriber units 103, the type of feedback requested and the spatial rank of the requested feedback. The base station 102 then sends a “sounding frame” known as a “null data packet” (NDP) frame. The NDP contains a physical layer (PHY) preamble with long training fields (LTFs), short training fields (STFs) and a signal (SIG) field. The NDP contains no data. The subscriber unit 103 then analyzes the NDP and provides back a report for each receive antenna (i.e., each SS). The base station 102 then uses the report to precode further transmissions to those subscriber units 103 from which reports were received. The reports are typically relatively large and require a significant amount of bandwidth. In some embodiments, such precoding is done by a combination of the coordination control module 1023 and the MBI module 801. In particular, in some embodiments, the MAC component 803 of the MBI module 801 applies precoding to signals output from the MBI module 801. In some embodiments, the coordination control module 823 may be coupled to the amplifier 813.

In accordance with the implicit technique for determining the SCI, the base station 102 requests the subscriber unit 103 to send the NDP frame. The base station 102 can then determine the precoding of the transmissions to the subscriber unit 103 based on the NDP frame without the report having to be communicated. This saves a substantial amount of bandwidth in the SCI procedure. In order to use the implicit technique, however, the uplink and downlink have to be reciprocal. While some differences may occur between the uplink and downlink of a mmWave system using TDD, the differences can typically be considered to be negligible when conditioning (e.g., precoding) the signals. That is, because the same frequency is used for both the uplink and the downlink, the channel characteristics will typically be the same or close enough to allow the information derived from the uplink to be used to precode signals on the downlink.

Accordingly, the implicit SCI procedure defined by the 802.11 standard can be used with a modification that the SSs output from the MBI module 801 have to be coordinated with the operation of the switch module 811 to ensure that the signals are transmitted to the desired subsector antennas, and thus to the intended subscriber units 103. In addition, beamforming that is performed by adjusting the gain and phase of the signals coupled to each subsector antenna 821 must be coordinated with the operation of the MBI module 801. The coordination control module 823 coupled to the MBI module 801 and the switch module 811 ensures the coordination of the switch module 811 and MBI module 801 during both the SCI procedure and normal operation.

As noted above, in addition to coordinating the SCI operations, the coordination control module 823 is also responsible for ensuring that SSs output from the MBI module 801 are routed by the switch module 811 to the appropriate feed of the appropriate subsector antenna 821 during normal operation. That is, the coordination control module 823 is responsible for ensuring that each SS output from the MBI module 801 is transmitted on the correct polarization and subsector antenna 821. In some embodiments, the coordination control module 823 has an output that is coupled over a signal line 824 to an input of the MBI module 801. The output from the coordination module 823 provides information that allows the MBI module 801 to determine that the SCI procedure can be performed (i.e., that the output from the MBI module 801 associated with channel being measured is coupled to the appropriate subsector antenna 821).

FIG. 10 is a simplified block diagram of one embodiment of some portions of a base station site 101, illustrating some of the details of the receive portion of a base station sector radio 407. For the sake of simplicity, only one base station sector radio 407 is shown in detail. In addition, only the components relevant to the receiver operation of the base station 102 are shown in FIG. 10. The operation of the receive sections of the base station 102 are similar to the operation of the transmit section. The signal flow however is from the subsector antenna 821 to the MBI 801. Signals received by the subsector antennas 821 are coupled to an RF receive (RX) chain 1002.

FIG. 11 is a simplified schematic of the components of the RF receive chain 1002. Each input 1101 of the RF receive chain 1002 is associated with a corresponding amplifier 1102, filter 1104, frequency converter 1106 and output 1108. Signals coupled to the RF receive chain 1002 are coupled to the input of the corresponding amplifier 1102. The output of the amplifier 1102 is coupled to the input of the corresponding filter 1104. The output of the filtered 1104 is coupled to the RF input of the corresponding frequency converter 1106. A local oscillator input to the frequency converter 1106 is coupled to an RF local oscillator (LO) 1110. The LO 1110 provides an LO signal to down convert the received RF signal to an IF frequency. The IF output of the frequency converter 1106 is then coupled to the output 1108 of the RF receive chain 1102.

Referring back to FIG. 10, the RX outputs from the switch module 811 are each associated with a corresponding filter 1004. Accordingly, the switch module 811 provides selectable one-to-one coupling of the outputs 1108 of the RF RX chain 1002 to the inputs of a filter 1004 within the IF RX module 805. The output of each filter 1004 is coupled to the input of a corresponding amplifier 1006. As noted above, the particular configuration of amplifiers and filters depends upon the requirements of the particular radio 407. Therefore, the configuration shown in FIG. 10 and FIG. 11 is merely provided as an example of one particular embodiment. Other configurations in which more or less amplifiers and filters placed at the same or other places along the signal path are within the scope of the presently disclosed method and apparatus.

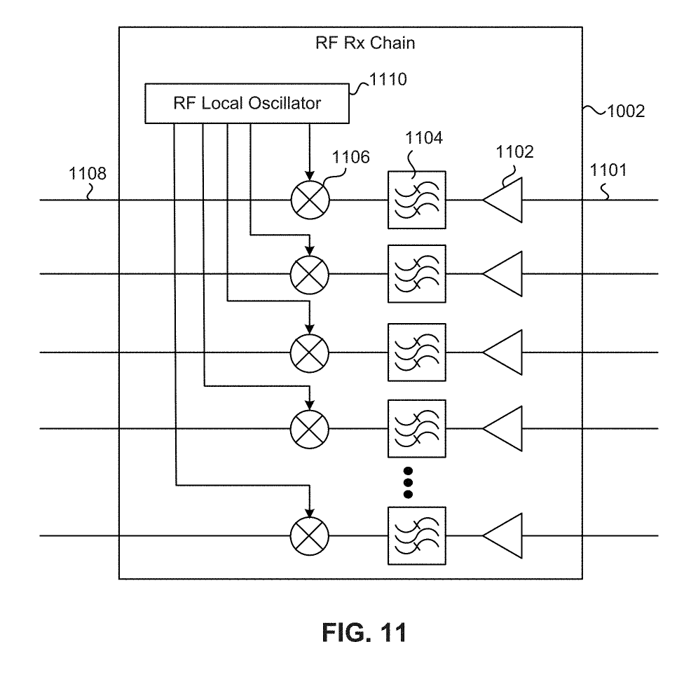

FIG. 12 is a simplified schematic of a base station site 1201 illustrating some of the transmit components of the sector radio 1207 in accordance with an alternative embodiment such as the base stations 702 shown in FIG. 7 in which a coordination control module 1223 is shared by all of the base stations 702. The coordination control module 1223 is responsible for coordinating the operation of the MBI modules 801 and switch modules 811 of each of base stations 702. In some embodiments, the coordination control module 1223 is a node on the WLAN 703 (see FIG. 7). The NIU 701 in each base station 702 is coupled to the MBI module 801 and IF module 805, so the coordination control module 1223 can coordinate the routing of SSs 802 through the switch module 811 of the IF module 805 with the assignment of the SSs 802 to the outputs of the MBI module 801. In some embodiments, the MAC component 803 of the MBI module 801 also adjusts the signals output from the MBI module 801 in response to the SCI measured during a SCI procedure. A control signal line 1224 between the NIU 701 and the MBI module 801 provides a connection through which the coordination control module 1223 can provide control signals to the MBI module 801 to coordinate the operation of the MBI module 801 with the operation of the switch module 811.

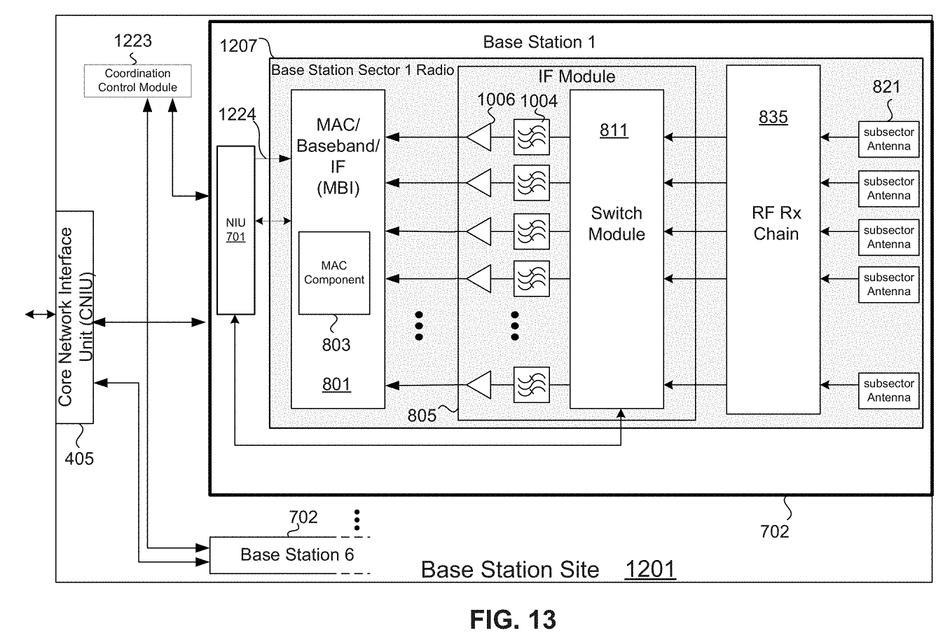

FIG. 13 is a simplified schematic of the base station site 1201 of FIG. 12 illustrating some of the receive components of the sector radio 1207. Similar to the case described above with respect to FIG. 12, the coordination control module 1223 provides signals to each base station 702 to coordinate control of the MBI 801 with the switch module 811. The signal flow through the base station radio 1207 is essentially the same as was described above with regard to the base station radio 407 of FIG. 10 with the exception of the coordination control module 1223 providing the control signals that coordinate the operation of the MBI 801 with the operation of the switch module 811.

The subsector antennas 821 within each base station sector radio 407 are a critical component of the base station 702. In accordance with some embodiments of the disclosure, each subsector antenna 821 is designed to focus signals into one of the subsectors 201 in the site coverage area 105.

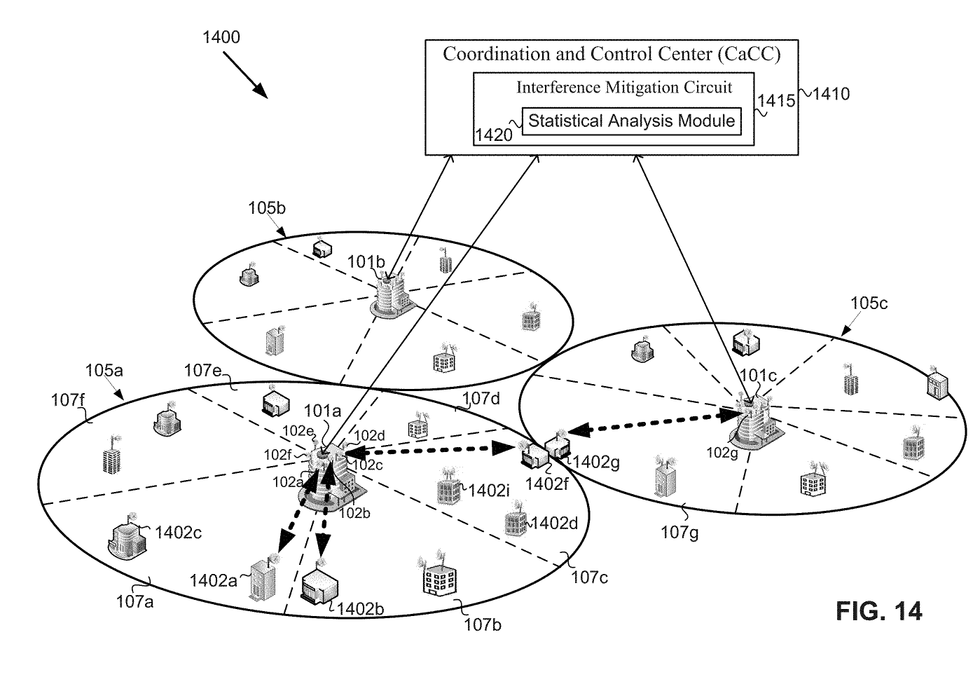

FIG. 14 is an illustration of multiple base station sites 101a-c within a radio frequency communication system 1400, such as a millimeter wave (mmWave) communication system. Each of the base station sites 101a-c is similar to the base station site 101 previously described in FIG. 1. Each site 101 has a site coverage area 105a-c, respectively and one or more base stations 102a-f. Each base station 102a-f is associated with a corresponding sector coverage area 107a-f. For example, base station 102a is associated with sector coverage area 107a within the site coverage area 105a of base station site 101a. One or more subscriber units 1402 reside within each sector coverage area 107, such as subscriber units 1402a and 1402b, which reside in sector coverage area 107b of base station 102b.

In the embodiment shown in FIG. 14, the radio frequency communication in base station sites 101a-c occurs over a Line of Sight (LoS) pathway (or link). Each of the base station sites 101a -c are configured to communicate with a Coordination and Control Center (CaCC) 1410, such as the previously described Coordination and Control Center 604. Such communications with the CaCC 1410 may be via a hardwired backhaul, fiber optic link, wireless line of sight or any other means for connecting the base stations 102 within the base station site 101 with the CaCC 1410.

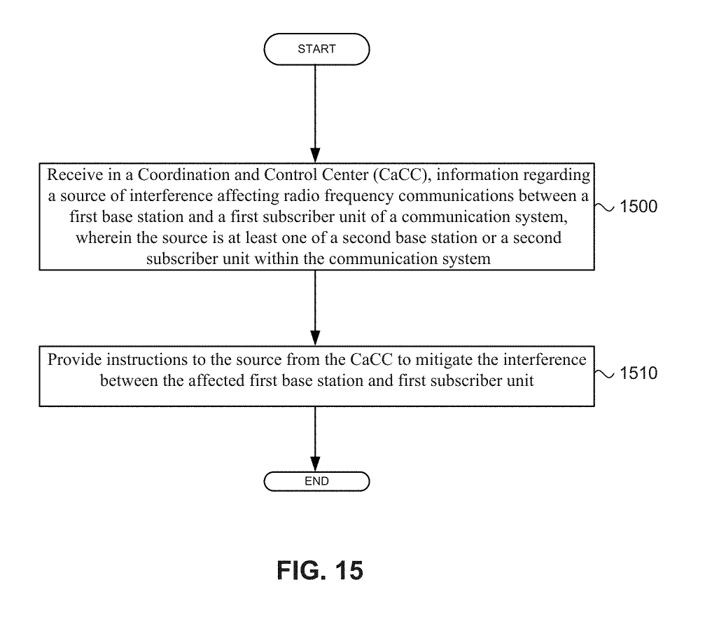

In some embodiments, the CaCC 1410 includes an Interference Mitigation Circuit 1415. As described in greater detail in conjunction with FIG. 15, the Interference Mitigation Circuit 1415 receives information regarding a source of interference affecting radio frequency communications between a base station 102 and a subscriber unit 1402, wherein the source is another base station 102 or a subscriber unit 1402 within the communication system 1400. The Interference Mitigation Circuit 1415 then analyzes the received information, such as via a Statistical Analysis Module 1420, and provides instructions to the source of the interference to mitigate its interference on the affected base station 102 or subscriber unit 1402, such as by the providing instructions for the source to reschedule or re-route its transmission, or to switch to another frequency channel or sub-channel.

FIG. 15 is a flow diagram illustrating the operation of some embodiments of the present disclosure for mitigating interferences in the communication system 1400 shown in FIG. 14. The process begins in block 1500 in which the CaCC 1410 receives information regarding a source of interference affecting radio frequency communication between a base station and a subscriber unit in the communication system 1400. The source is another base station 102 or subscriber unit 1402 within the communication system 1400. As described further and in greater detail in conjunction with example scenarios A-C below, the source of interference may be a base station 102 transmitting signals that are interfering with reception by another base station 102 or a subscriber unit 1402 residing in the same or different base station site 101 as the source of the interference. For example, the source of the interference may be a base station 102b, whose transmissions are interfering with communication between an affected base station 102a and its subscriber unit 1402c, as shown in FIG. 14. Alternatively, the source of the interference may be a subscriber unit 1402c that is transmitting signals that interfere with reception by another subscriber unit 1402a or a base station 102b residing in the same or different base station site 101a as the source of the interference.

In some embodiments, the operation in block 1500 includes determining information such as: (a) the location of the interference source (e.g., the base station 102b); (b) the location of the affected base station (e.g., the base station 102a); or (c) the location of the affected subscriber unit (e.g., the subscriber unit 1402c). In some embodiments, determining the location of the source of the interference may be based on: (a) obtained statistical data corresponding to the source of the interference, such as from standards-based channel information (e.g., channel state information); and (b) one or more of: (1) a time-based determination (e.g., Time of Arrival, Time Difference of Arrival); (2) a power-based determination (e.g., Returned Signal Strength Indicator), or (3) an angle-based determination (e.g., Angle of Arrival). In some embodiments, the Statistical Analysis Module 1420 is configured to perform the above determination methods. In some embodiments, the Statistical Analysis Module 1420 performs other determination methods as well or instead, such as utilizing analytic tools and procedures, such as machine learning to generate a set of power-based data. In at least some embodiments, the information is attained from several sources (i.e., base stations 102 and/or subscriber units 1402) and used together to determine the location and nature of the source of interference.

It should be noted that for simplicity of illustration the CaCC 1410 is shown in FIG. 14 as residing in a single location remote to the base stations sites 101a-c, but it is contemplated that the CaCC 1410 may also reside partially or fully in one or more of the base station sites 101a-c, base stations 102 or in one or more of the subscriber units 1402. In the case in which the CaCC 1410 resides in at a base station site 101, it may perform one or more of the above interference determinations, such as determining the locations of the source of interference, the location of the affected base stations 102 or subscriber unit 1402, and thereafter communicate the relevant information to a remote or locally residing Interference Mitigation Circuit 1415 of the CaCC 1410.

Information received in block 1500 is then used in block 1510 to generate instruction for mitigating of the interference generated by the source on communications between the affected base station and subscriber unit. The information is communicated by the CaCC 1410 to the source to perform the mitigation. In the case in which the CaCC 1410 and Interference Mitigation Circuit 1415 reside within the base station site 101 associated with the source of the interference, the CaCC 1410 need not communicate with devices outside the base station site 101 to mitigate the interference. Alternatively, if the CaCC 1410 or the Interference Mitigation Circuit 1415 reside outside the base station site 101 associated with the source of the interference 1415, then the CaCC must communicate over longer distances. Such distances can add to the latency of the communication. Therefore, in some embodiments, a CaCC 1410 and Interference Mitigation Circuit 1415 are provided within each base station site 101. Such CaCCs 1410 may commutate with one another over a backhaul. Different approaches may be used to mitigate the interference depending upon the situation. As described further and in greater detail in conjunction with example scenarios (A)-(C) below, approaches for mitigating the interference may include rescheduling transmissions by the source, such as by postponing transmissions to a later time at which interference is estimated by the CaCC 1410 to be lower than at other times. In addition, transmissions can be re-routed, such as by redirecting the communication via beamforming techniques from the source to a different intended receiver, such as via rerouting to an alternate path provided by the CaCC 1410. The CaCC 1410 determines if the provided path results in reduction of interference by the source on the affected communication between the base station and the subscriber unit. Alternatively, mitigating the interference may include providing instructions by the CaCC 1410 for changing the transmissions by the source to a different frequency, or to a different sub-channel within a frequency.

Operations described above in FIG. 15 will now be described in greater detail in the following example scenarios:

### Scenario A

Scenario A includes examples of situations in which interference occurs due to transmissions intended for a base station 102 or a subscriber unit residing in one sector coverage area that interferes with the reception by a base station or a subscriber unit residing in another sector coverage area within the same base station site coverage area 105.

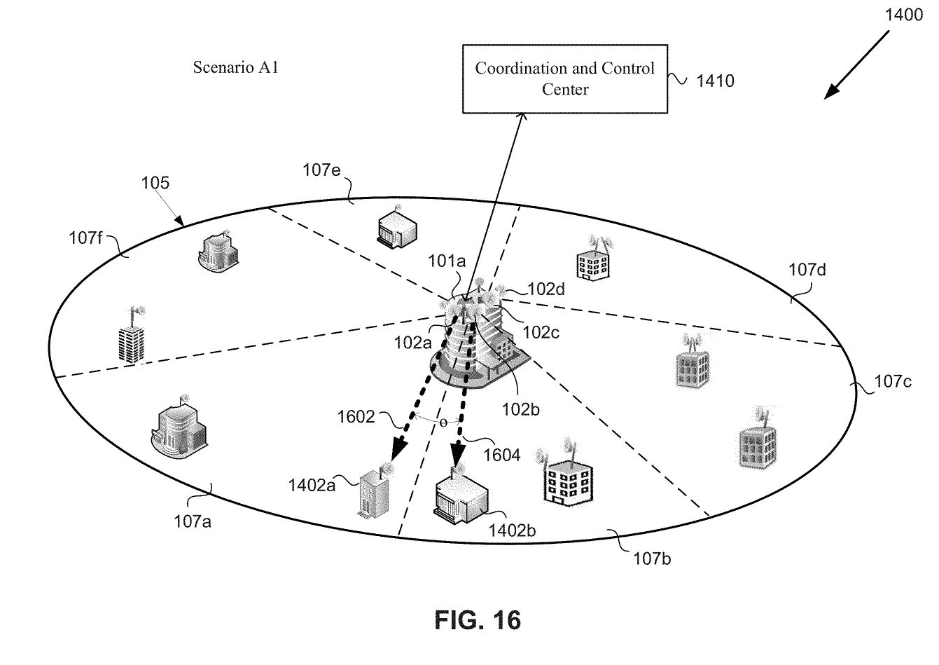

Scenario Al illustrated in FIG. 16, shows signals transmitted from a base station 102a to a subscriber unit 1402a located in a sector coverage area 107a of a base station site coverage area 105 interfere with communications between another base station 102b and a subscriber unit 1402b in an adjacent sector coverage area 107b of the same base station site coverage area 105. In one scenario, the interference is due to the separation angle (θ) between the transmission paths 1602 and 1604 being less than the required angular separation to prevent an overlap between the main lobe or side lobes of the transmission signals 1602, 1604, or other such antenna pattern interference, in signal transmitted from the base stations 102a and 102b to their corresponding subscriber units 1402a and 1402b.

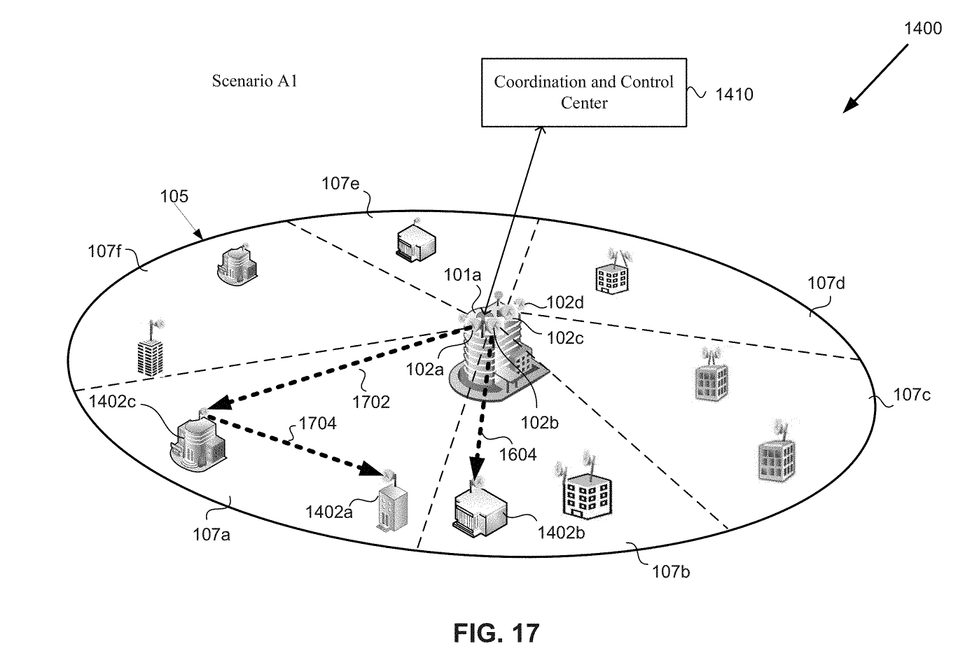

Following the operations described in FIG. 15, the CaCC 1410 provides the base station 102b with instructions to take action to mitigate the interference, such as by rescheduling transmissions so that the base station 102a communicates with its subscriber unit 1402a at times that are different from the times when the base station 102b is transmitting. Alternatively, or additionally, changing the transmissions by the base station 102a to a different frequency or OFDMA sub-channel so to not interfere with transmissions from the base station 102b. The CaCC 1410 instructions may also re-route communications of the base station 102a with the subscriber unit 1402a through signal paths 1702, 1704 that relays signals through a third subscriber unit 1402c, as shown in FIG. 17. In some embodiments, re-routing may send the signal through a different base station 102 or base station site 101. Alternatively, any combination of the above mitigation methods can be used.

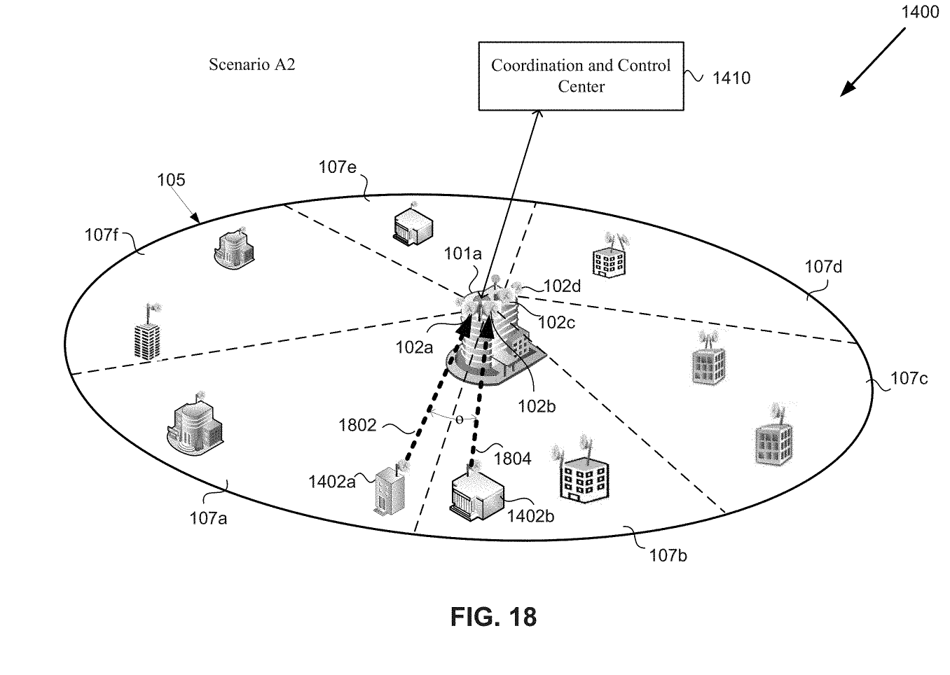

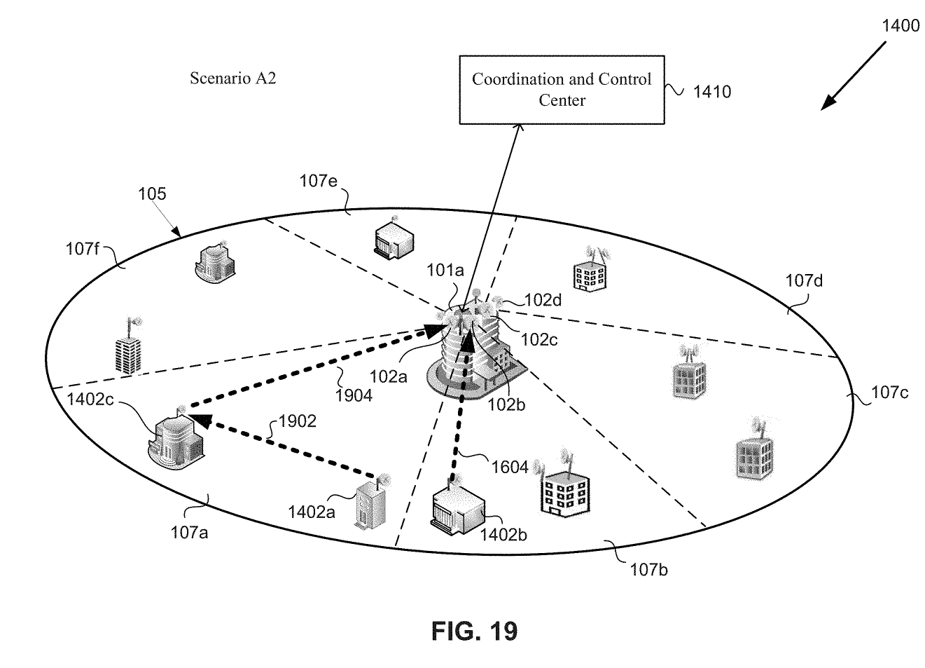

Scenario A2 illustrated in FIG. 18, shows transmissions from a subscriber unit 1402a to its corresponding base station 102a interfere with reception by a base station 102b attempting to receive signals from a subscriber unit 1402b. In one such scenario, this interference can be due to the separation angle (θ) between the transmission paths 1802 and 1804 being less than a predetermined minimum angle, resulting in overlaps between the main lobe or side lobes of each transmission signal, or other such antenna pattern interference, in signals transmitted from the subscriber units 1402a and 1402b to their corresponding base stations 102a and 102b. The CaCC 1410 may provide instructions to subscriber unit 1402a to (a) reschedule its transmission, (b) change the transmissions frequency or sub-channel, (c) re-route through a different route, such as over signal path 1902 to the subscriber unit 1402c and then over a signal path 1904 to base station 102a, as shown in FIG. 19, or (d) any combination of the above mitigation methods.

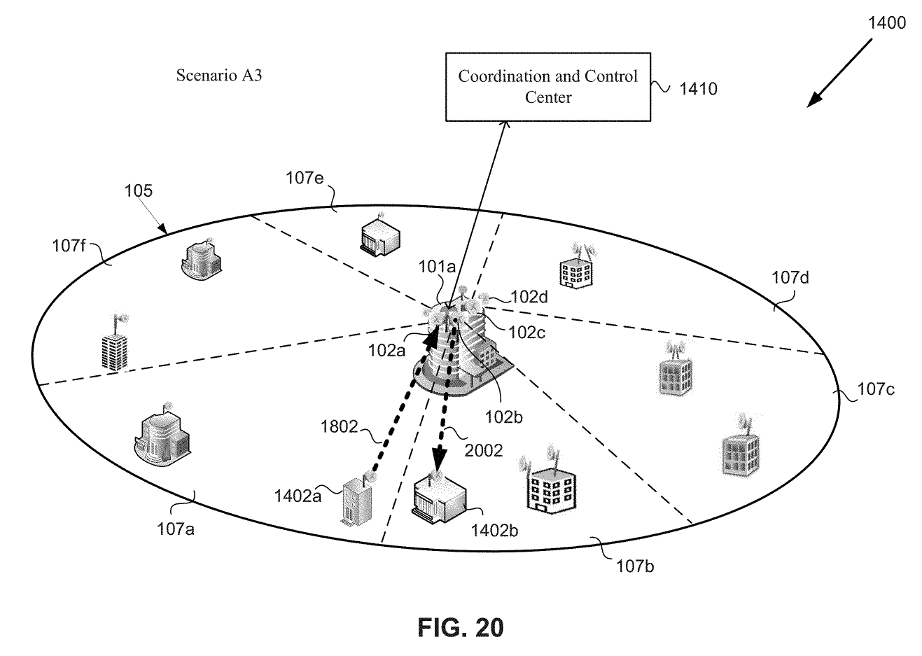

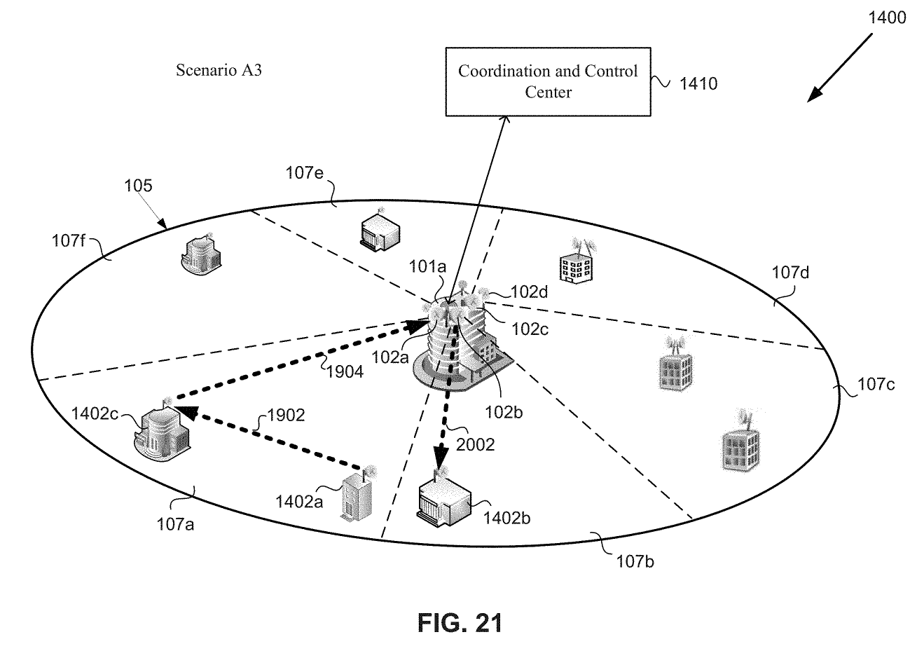

Scenario A3 illustrated in FIG. 20, shows transmissions from a subscriber unit 1402a may interfere with another subscriber unit 1402b in an adjacent sector coverage area 107b that is attempting to receive signals 2002 from the base station 102b. The CaCC 1410 may then similarly provide instructions to the subscriber unit 1402a to: (a) reschedule its transmission; (b) change the transmissions frequency or sub-channel; (c) re-route transmissions through a different route, such as through paths 1902, 1904 through subscriber unit 1402c as shown in FIG. 21; or (d) any combination of the above mitigation methods.

### Example Scenarios (B)

These example scenarios occur when transmissions by a base station or a subscriber unit in a first base station site, interferes with receptions by another base station or a subscriber unit in a second base station site.

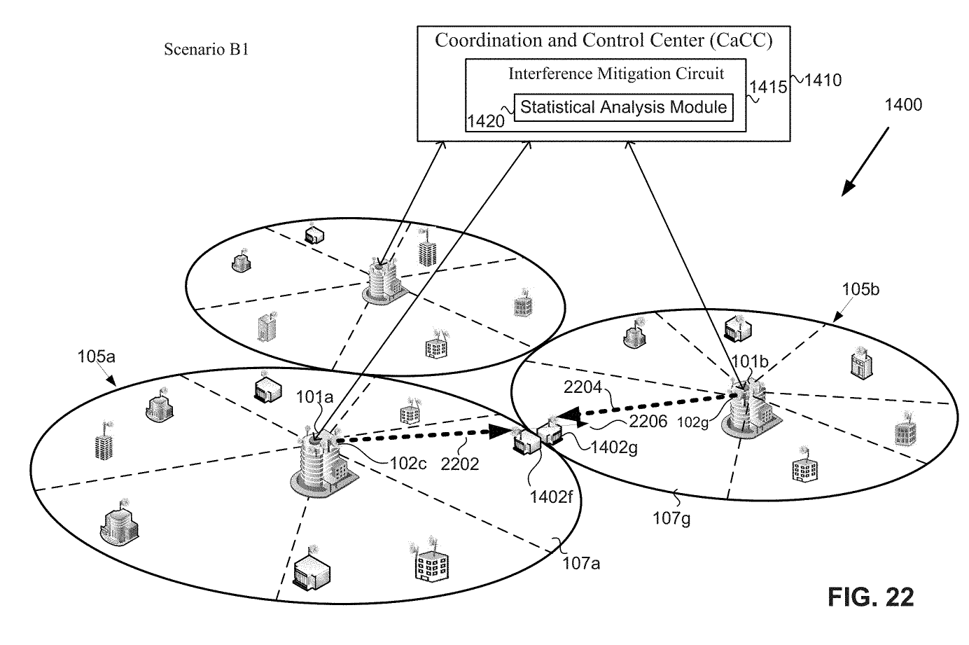

Scenario B1 illustrated in FIG. 22 shows transmissions by the base station 102c via a line of sight signal path 2202 to the subscriber unit 1402f in sector coverage area 107a interferes with reception by a subscriber unit 1402g of transmissions via signal path 2204 from the base station 102g in base station site coverage area 105b. One reason for such interference is that the line of sight signals in the communication system 1400 are focused. Therefore, the strength of such LoS signals (relative to the strength of signals that experience R² roll-off when transmitted from less focused antennas) is still significant when the signal reaches a subscriber unit in the line of sight of the signal. This is due to the relatively high antenna gain of antennas used to transmit such LoS signals, as compared to the gain of antennas with wider transmission angles, such as those in cellular telephone networks. This relatively high signal strength can make it challenging to contain signals within the sector serviced by a base station 102. That is, to ensure that a signal has sufficient power at the edge of the sector coverage area 107, the signal transmitted to a subscriber unit 1402 will typically propagate well beyond that sector 107 (see signal 2206, for example). Accordingly, the signal will propagate into the sector coverage areas 107 of adjacent base station sites 101, such as sector coverage area 107b of the base station site 101b. Accordingly, the signals from the base station 102b intended for subscriber unit 1402g may interfere with reception by the subscriber unit 1402f from the base station 102c.

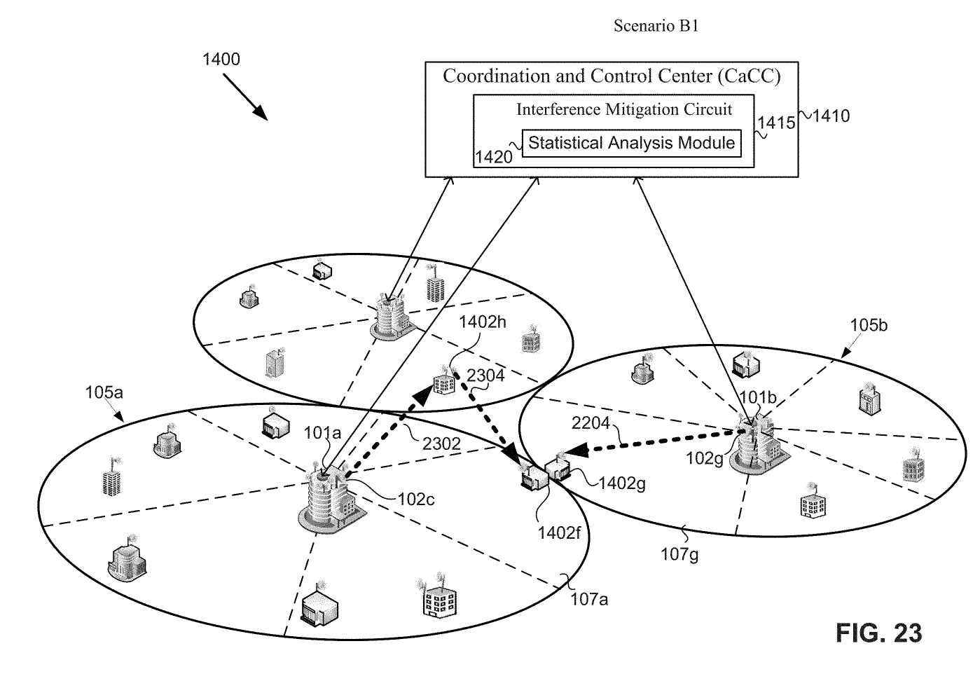

In Scenario B1, the CaCC 1410 provides instructions to the base station 102a to take actions to mitigate the interference on receptions by the subscriber unit 1402g, such as via (a) rescheduling when base station 102a communicates with the subscriber unit 1402a, so that it is not transmitting at the same time as base station 102g, (b) changing the transmissions frequency or sub-channel of transmissions by base station 102a; (c) as illustrated in FIG. 23, re-route transmissions from base station 102c, such as to subscriber unit 1402h over a different route such as path 2302 to the subscriber unit 1402h in the base station site coverage area 105c and then over path 2304 from the subscriber unit 1402h to the subscriber unit 1402f; or (d) any combination of the above mitigation methods.

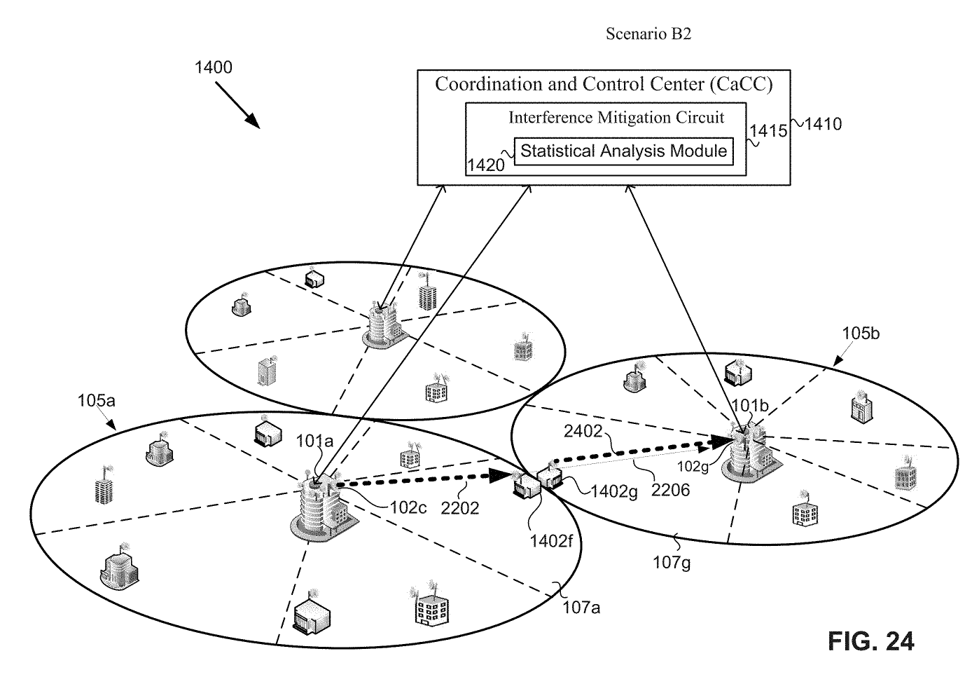

Scenario B2 illustrated in FIG. 24 shows transmissions from the base station 102c within the base station site 101a interfering with base station 102g in base station site 101b attempting to receive signals from subscriber unit 1402g in sector coverage area 107g. The strength of the signal transmitted by the base station 102c to a subscriber unit 1402f may be such that it reaches the base station 102g with sufficient power to interfere with that base station's ability to receive signals from the subscriber unit 1402g.

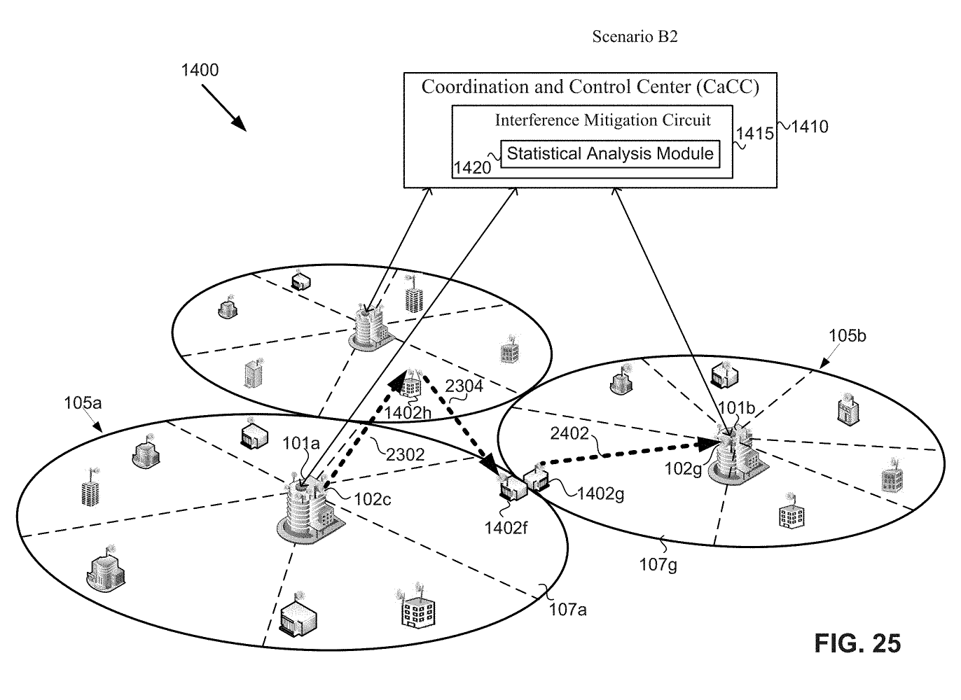

In Scenario B2, the CaCC 1410 provides instructions to the base station 102c to take actions to mitigate the interference with attempts by the base station 102g to receive signals from subscriber unit 1402g. Such mitigation may include: (a) rescheduling of transmissions from base station 102c so to not occur at the same time as that of subscriber unit 1402g; (b) changing the transmissions frequency or sub-channel of signals transmitted from base station 102c; (c) as illustrated in FIG. 25, re-routing signals transmitted by base station 102c through a different route, such as over path 2302 to the subscriber unit 1402h and path 2304 to subscriber unit 1402f, such that the signal propagating past the subscriber unit 1402c along path 2304 will not extend in the direction of the base station 102g; or (d) any combination of the above mitigation methods.

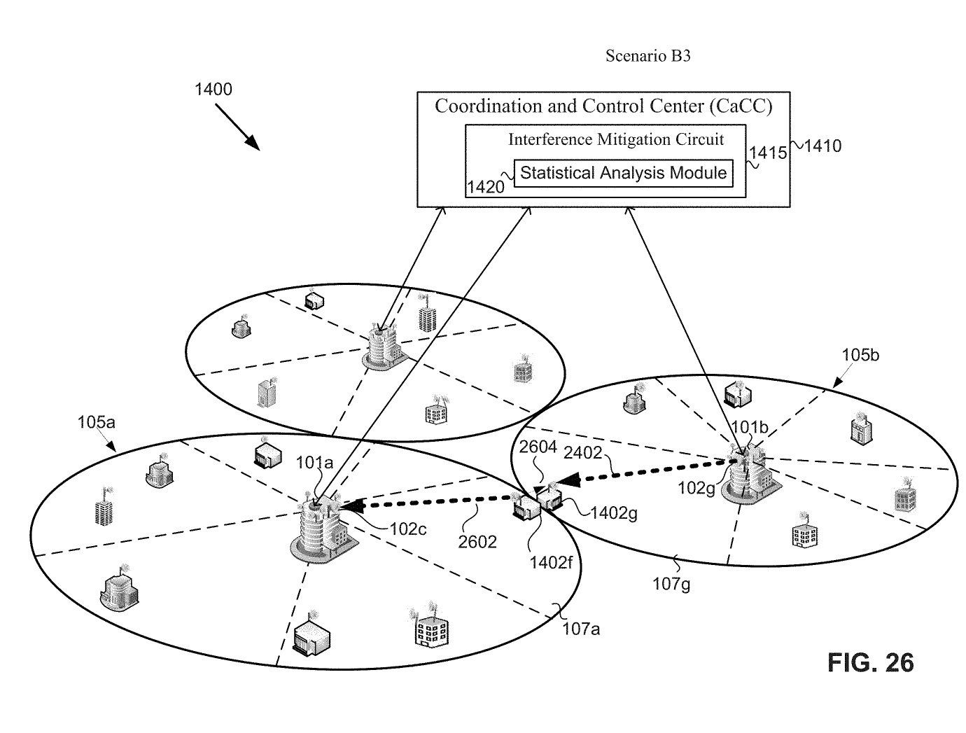

Scenario B3 illustrated in FIG. 26 shows transmissions 2602 from a subscriber unit 1402f interfering with reception by a subscriber unit 1402g in another site coverage area 105b. While the transmissions 2602 from the subscriber unit 1402f are intended to be received by the base station 102c, which is located in the opposite direction of the subscriber unit 1402g, transmission 2604 via the back lobes of the transmit antenna of the subscriber unit 1402f might be of sufficient power to reach the subscriber unit 1402g and so cause interference with attempts by subscriber unit 1402g to receive signals from the base station 102g. In some cases, the subscriber units 1402f and 1402g have antennas that are not directional (e.g., omni-directional antennas). In such cases, the antennas will transmit and receive signals from all directions with essentially equal power.

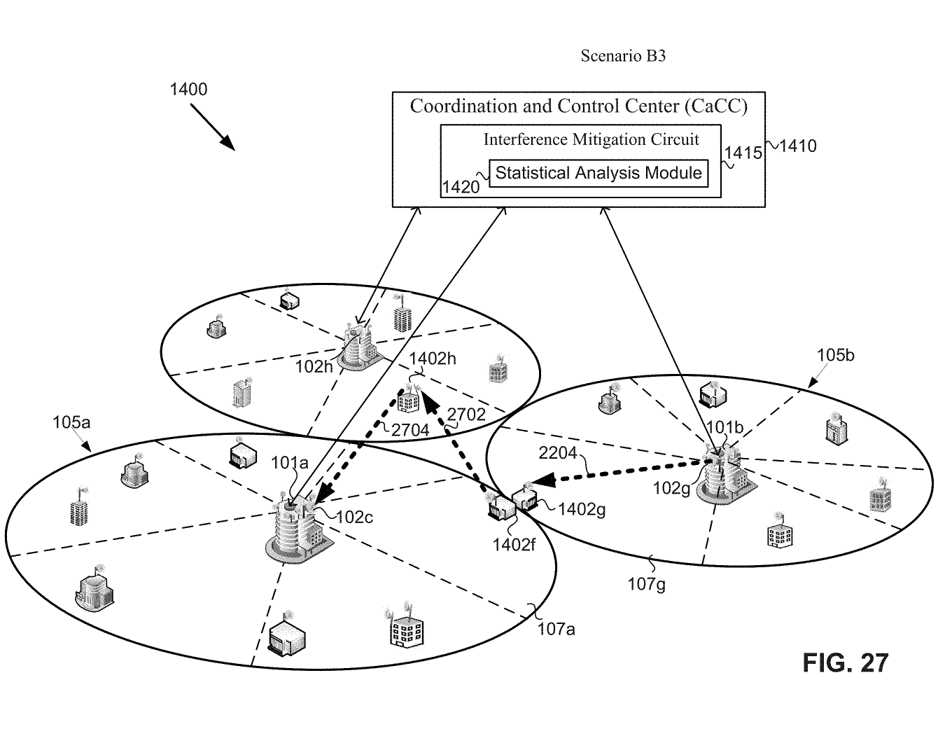

In Scenario B3, the CaCC 1410 provides instructions to the subscriber unit 1402f to take actions to mitigate the interference on receptions by the subscriber unit 1402g, such as by (a) rescheduling of communication from the subscriber unit 1402f to times that do not occur at the same time as transmissions from the base station 102g to the subscriber unit 1402g, (b) changing the transmissions frequency or sub-channel of transmissions from the subscriber unit 1402f, (c) as shown in FIG. 27, re-routing through a different route such as path 2702 through subscriber unit 1402h to signal path 2704; or (d) any combination of the above mitigation methods. In cases in which the CaCC 1410 is instructing a subscriber unit 1402h, the base station 102h that is in communication with the subscriber unit 1402h receives instructions from the CaCC 1410, which are then conveyed to the subscriber unit 1402h. It should be noted that re-routing signals 2702, 2704 may only work to avoid interference if the antenna pattern changes when signals are re-routed.

### Example Scenarios (C)

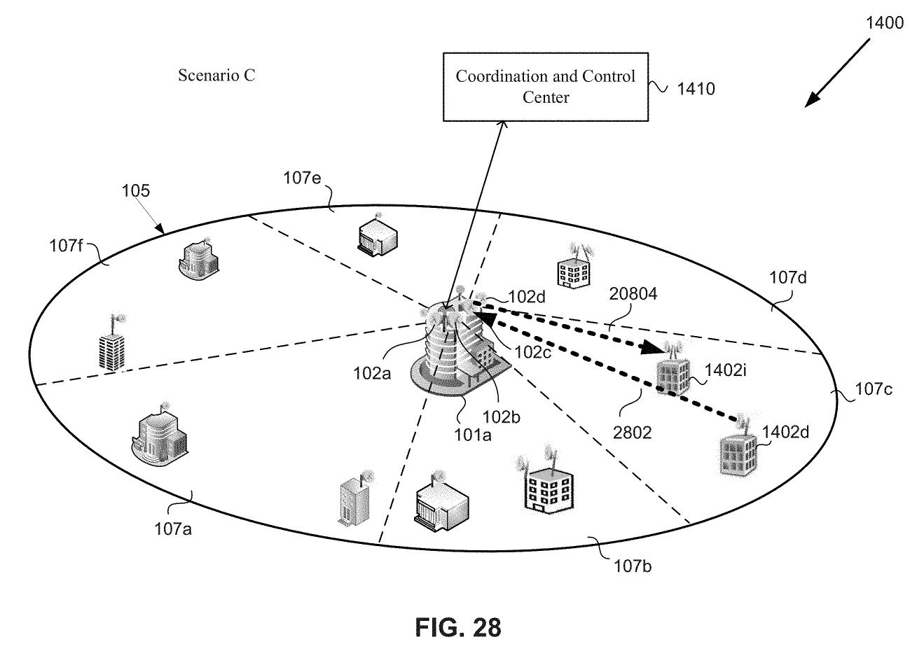

These example scenarios occur when transmissions from one subscriber unit interferes with reception by another subscriber unit located in the same sector as the affected subscriber unit. In an example scenario shown in FIG. 28, transmissions 2802 from the subscriber unit 1402d interfere with reception by subscriber unit 1402i of transmissions 2804 from the base station 102c. The CaCC 1410 then provides instructions to the subscriber unit 1402d through the base station 102c to take actions to mitigate the interference on reception by the subscriber unit 1402i, such as via (a) rescheduling of subscriber unit 1402d communication times so as to not occur at the same time as that transmissions from the base station 102c to subscriber unit 1408; (b) changing the transmission frequency or sub-channel of subscriber unit 1402d communication; (c) reroute subscriber unit 1402d communication through a different route; or (d) any combination of the above mitigation methods.

It is to be understood that the foregoing description is intended to illustrate, and not to limit, the scope of the claimed invention. Accordingly, other embodiments are within the scope of the claims. Note that paragraph designations within claims are provided to make it easier to refer to such elements at other points in that or other claims. They do not, in themselves, indicate a particular required order to the elements. Further, such designations may be reused in other claims (including dependent claims) without creating a conflicting sequence.

The previous description is provided to enable any person skilled in the art to practice the various aspects described herein. Various modifications to these aspects will be readily apparent to those skilled in the art, and the generic principles defined herein may be applied to other aspects.

1. A method comprising:
a) determining in a Coordination and Control Center (CaCC), information regarding a source of interference affecting radio frequency communications between a first base station and a first subscriber unit of a communication system, wherein the source is at least one of a second base station or a second subscriber unit within the communication system; and
b) providing instructions to the source from the CaCC to mitigate the interference between the affected first base station and first subscriber unit.

2. The method of claim 1, wherein the radio frequency communications occurs over a line-of sight pathway.

3. The method of claim 1, wherein providing instructions to mitigate includes rescheduling transmissions from the source.

4. The method of claim 3, wherein the rescheduling includes postponing transmissions to a later time at which interference is as lower based on the estimates by the CaCC.

5. The method of claim 1, wherein providing instructions to mitigate includes re-routing transmissions from the source.

6. The method of claim 1, wherein providing instructions to mitigate includes changing the frequency of the source to a different frequency.

7. The method of claim 1, wherein providing instructions to mitigate includes changing a sub-channel on which the source is transmitting to a different sub-channel.

8. The method of claim 1, the information regarding the source comprising a location of the source.

9. The method of claim 1, the information regarding the source comprising a location of the affected first base station.

10. The method of claim 1, the information regarding the source comprising a location of the affected subscriber unit.

11. The method of claim 1, wherein the first base station resides at a base station site having a plurality of base stations, each base station associated with a corresponding sector of the base station site, the source being a second base station within the base station site.

12. The method of claim 1, wherein the first base station resides at a base station site having a plurality of base stations, each base station associated with a corresponding sector of the base station site, the source being a second subscriber unit in communication with a second base station within the base station site.

13. The method of claim 1, wherein the communication system includes a plurality of base station sites, each base station site having a plurality of base stations, the first base station residing within a first plurality of base stations corresponding to the first base station site, and the second base station residing within a second plurality of base stations corresponding to the second base station site, the source being the second base station.

14. The method of claim 1, wherein the communication system includes a plurality of base station sites, each base station site having a plurality of base stations, the first base station residing within a first plurality of base stations corresponding to the first base station site, and the second base station residing within a second plurality of base stations corresponding to the second base station site, the source being a subscriber unit in communication within the second base station.

15. The method of claim 1, wherein in the CaCC resides in a location (a) remote to a base station, or (b) within a base station or a subscriber unit.

16. A communication device, comprising:
a Coordination and Control Center (CaCC) in communication with a plurality of base stations including a first base station and a first subscriber unit of a communication system, the CaCC including an Interference Mitigation Circuit configured to:
(a) determine information regarding a source of interference affecting radio frequency communications between a first base station and a first subscriber unit of a communication system, wherein the source is at least one of a second base station or a second subscriber unit within the communication system; and
(b) provide instructions to the source from the CaCC to mitigate the interference between the affected first base station and first subscriber unit.

17. The communication device of claim 16, further comprising,
a Statistical Analysis Module configured to determine locations of (a) the source, (b) the affected first base station or (c) the affected subscriber units.

18. The communication device of claim 16, wherein the instructions to mitigate includes instructions to the second base station or the second subscriber unit to (a) reschedule or re-route communication, or (b) switch to a non-interfering sub-channel in the communication frequency.

19. The communication device of claim 16, wherein the instructions to re-route includes instructions to redirect from the source to a different intended receiver.

20. The communication device of claim 16, wherein the instructions to reschedule includes instructions to postpone communication transmission to a later time at which interference is estimated by the CaCC to be lower than at other possible times based on the determination.

21. The communication device of claim 16, wherein the first base station resides at a base station site having a plurality of base stations, each base station associated with a corresponding sector of the base station site, the source being a second base station within the base station site.

22. The communication device of claim 16 wherein the first base station resides at a base station site having a plurality of base stations, each base station associated with a corresponding sector of the base station site, the source being a second subscriber unit in communication with a second base station within the base station site.

23. The communication device of claim 16, wherein the communication system includes a plurality of base station sites, each base station site having a plurality of base stations, the first base station residing within a first of the plurality of base station sites and a second base station residing within a second first of the plurality of base station sites, the source being the second base station.

24. The communication device of claim 16, wherein the communication system includes a plurality of base station sites, each base station site having a plurality of base stations, the first base station residing within a first of the plurality of base station sites and a second base station residing within a second base station site, the source being a subscriber unit in communication within the second base station.

25. The communication device of claim 16, wherein in the CaCC resides in a location (a) remote to a base station, or (b) within a base station or a subscriber unit.
